(19) United States
(12) Patent Application Publication
(10) Pub. No.: US 2025/0378004 A1
(43) Pub. Date: Dec. 11, 2025

(54) CODE IMPROVEMENT DEVICE, CODE IMPROVEMENT METHOD, AND RECORDING MEDIUM

(71) Applicant: NEC Corporation, Tokyo (JP)

(72) Inventors: Kenji ARAKI, Tokyo (JP); Seiya SHIBATA, Tokyo (JP)

(73) Assignee: NEC Corporation, Tokyo (JP)

(21) Appl. No.: 19/227,679

(22) Filed: Jun. 4, 2025

(30) Foreign Application Priority Data
Jun. 11, 2024 (JP) 2024-094439

(51) Int. Cl. G06F 11/3604

(52) U.S. Cl. CPC G06F 11/3608

(57) ABSTRACT

A code improvement device includes a code improvement unit, an execution unit, an evaluation unit, and a determination unit. The code improvement unit improves a code of a program, to generate a post-improvement code, using a language model that improves a code of a program based on a prompt indicating an improvement content of the code of the program. The execution unit executes a process using the post-improvement code. The evaluation unit evaluates the execution performance of the code based on the execution result of the post-improvement. The determination unit determines whether to use the post-improvement code based on the evaluation result of the execution performance.

This application is based upon and claims the benefit of priority from Japanese

Patent Application No. 2024-94439, filed on Jun. 11, 2024 the disclosure of which is incorporated herein in its entirety by reference.

### TECHNICAL FIELD

The present disclosure relates to a code improvement device and the like.

### BACKGROUND ART

In the improvement of the program, it is necessary to repeat the code rewriting, the execution, and the evaluation of the code based on the execution result, and thus, a system for generating a code may be used. For example, a processor of PTL 1 (JP 2023-47334 A) extracts metadata regarding a program to be generated. The processor of JP 2023-47334 A generates a code of the program using the metadata as an input of the language model.

### SUMMARY

An object of the present disclosure is to provide a code improvement device or the like capable of efficiently improving a code of a program.

A code improvement device according to an aspect of the present disclosure includes a code improvement unit that improves a code of a program, to generate a post-improvement code, using a language model that improves a code of a program based on a prompt indicating improvement content of the code of the program, an execution unit that executes a process using the post-improvement code, an evaluation unit that evaluates execution performance of the post-improvement code based on an execution result of the post-improvement code, and a determination unit that determines whether to use the post-improvement code based on an evaluation result of the execution performance.

A code improvement method according to an aspect of the present disclosure includes improving a code of a program, to a post-improvement code, using a language model that improves a code of a program based on a prompt indicating improvement content of the code of the program, executing a process using the post-improvement code, evaluating execution performance of the post-improvement code based on an execution result of the post-improvement code, and determining whether to use the post-improvement code based on an evaluation result of the execution performance.

A recording medium according to an aspect of the present disclosure non-transitorily records a code improvement program for causing a computer to execute the steps of improving a code of a program, to generate a post-improvement code, using a language model that improves a code of a program based on a prompt indicating improvement content of the code of the program, executing a process using the post-improvement code, evaluating execution performance of the code based on an execution result of the post-improvement code, and determining whether to use the post-improvement code based on an evaluation result of the execution performance.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of a code improvement system according to the example embodiment of the present disclosure;

FIG. 2 is a diagram illustrating an example of a configuration of a code improvement device according to the example embodiment of the present disclosure;

FIG. 3 is a diagram illustrating an example of a configuration of a code improvement system according to the example embodiment of the present disclosure;

FIG. 4 is a diagram illustrating an example of a configuration of a code improvement system according to the example embodiment of the present disclosure;

FIG. 5 is a diagram illustrating an example of a display screen according to the example embodiment of the present disclosure;

FIG. 6 is a diagram illustrating an example of a display screen according to the example embodiment of the present disclosure;

FIG. 7 is a diagram illustrating an example of an operation flow of the code improvement device in the example embodiment of the present disclosure; and

FIG. 8 is a diagram illustrating an example of a hardware configuration of the code improvement device according to the example embodiment of the present disclosure.

### EXAMPLE EMBODIMENT

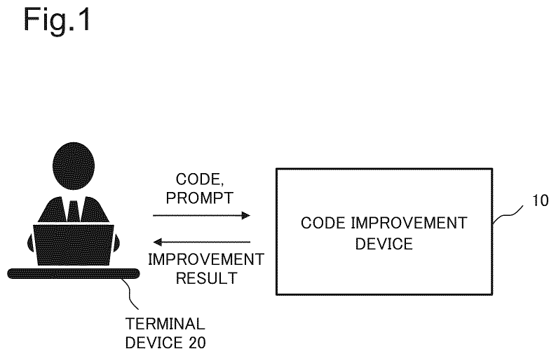

The example embodiments of the present disclosure will be described in detail with reference to the drawings. FIG. 1 is a diagram illustrating an example of a configuration of a code improvement system. The code improvement system includes, for example, a code improvement device 10 and a terminal device 20. The code improvement device 10 is connected to the terminal device 20 via, for example, a network. A plurality of terminal devices 20 may be provided. The number of terminal devices 20 can be appropriately set.

The code improvement system is, for example, a system that improves the code of a program. The code improvement system improves, for example, the execution performance of the code by improving the code of the program whose operation has been confirmed. The code is, for example, a source code of a computer program executed by the information processing device. The code may be a test code. The operation confirmed means that, for example, in a case where a code is executed, it is confirmed that correct output data is acquired for input data. Improving the code means, for example, changing part of the code in a state in which the code is executable.

The code improvement system improves a code using, for example, a language model that generates a code based on a prompt and a code using the prompt and the code to be improved as inputs. The prompt includes, for example, information indicating improvement content of the code. That is, the code improvement system improves the code based on the prompt, for example, using the prompt and the code as inputs to a language model. As the language model, for example, a natural language model called a large-scale language model can be used. An example of the language model will be described later.

The execution performance of the code is, for example, an index indicating efficiency at the time of executing the code. For example, the execution performance of the code is, for example, an index related to resources required at the time of executing the code. For example, the smaller the resources required to execute the code, the higher the execution performance of the code. For example, the execution performance of the code includes at least one of an execution time of the code, a memory consumption amount at the time of executing the code, and an index related to power consumption at the time of executing the code. The execution performance of the code may include, for example, an index indicating efficiency at the time of confirming or improving the code. For example, code execution performance may include code readability. The execution performance of the code is not limited to the above.

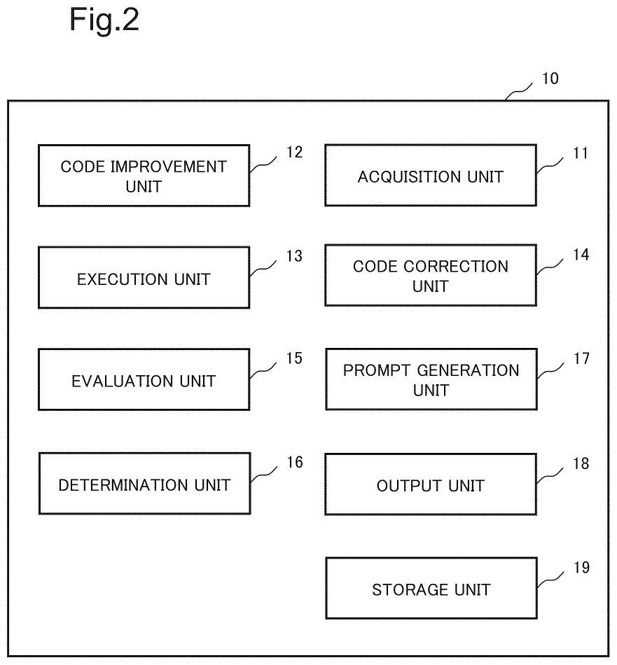

Here, an example of a configuration of the code improvement device 10 will be described. FIG. 2 is a diagram illustrating an example of a configuration of the code improvement device 10. The code improvement device 10 includes a code improvement unit 12, an execution unit 13, an evaluation unit 15, and a determination unit 16 as a basic configuration. The code improvement device 10 may include, for example, an acquisition unit 11, a code correction unit 14, a prompt generation unit 17, an output unit 18, and a storage unit 19.

The acquisition unit 11 acquires, for example, a code of a program to be improved. For example, the acquisition unit 11 acquires, as a code of a program to be improved, a code for which it is confirmed that no error occurs at the time of execution. For example, the acquisition unit 11 acquires, as a code of a program to be improved, a code for which it is confirmed that correct output data is acquired with respect to input data at the time of executing the code. The code of the program to be improved is input to the terminal device 20 by, for example, a person in charge of improving the code. The acquisition unit 11 acquires a code of a program to be improved from the terminal device 20, for example. The acquisition unit 11 may acquire the code of the program to be improved via an input device (not illustrated) connected to the code improvement device 10. The program code to be improved may be stored in the storage unit 19.

The acquisition unit 11 acquires, for example, correct answer data of input/output data in a code to be improved. The correct answer data of the input/output data is, for example, data obtained by combining input data with output data in a case where a code that normally operates is executed. That is, the input/output data is, for example, test data for verifying the operation of the code. The correct answer data of the input/output data in the code to be improved is input to the terminal device 20 by, for example, a person in charge of improving the code. The acquisition unit 11 acquires, for example, correct answer data of the input/output data in the code to be improved from the terminal device 20. The acquisition unit 11 may acquire correct answer data of input/output data in a code to be improved via an input device (not illustrated) connected to the code improvement device 10. The correct answer data of the input/output data in the code to be improved may be stored in the storage unit 19.

For example, the acquisition unit 11 acquires a prompt indicating the content of the code improvement. The acquisition unit 11 may acquire information indicating a change point of the prompt. The prompt indicating the content of the code improvement is input to the terminal device 20 by, for example, a person in charge of performing the code improvement. The acquisition unit 11 acquires a code of a program to be improved from a terminal device (not illustrated), for example. The acquisition unit 11 may acquire the code of the program to be improved via an input device (not illustrated) connected to the code improvement device 10.

The code improvement unit 12 improves the code of the program using the language model. The language model enhances the code based on a prompt indicating improvement content of a code of a program. The language model is, for example, a machine learning model that outputs a code changed based on a prompt using the prompt and the code as inputs. For example, the language model outputs an improved code based on the prompt using a prompt indicating improvement content of a code of “Please speed up the following code” and a code to be improved as inputs.

Improving the code means, for example, changing at least part of the code. That is, the language model performs a process of changing at least part of the code based on the prompt. The code generated in the processing in which the language model changes at least part of the code based on the prompt may include a code whose execution performance is not improved as compared with the pre-improvement code.

As the language model, for example, Generative Pre-trained Transformer-2 (GPT-2), GPT-3, GPT-3.5, or GPT-4 can be used. Examples of the language model may include text-to-text transfer transformer (T5), bidirectional encoder representations from transformers (BERT), robustly optimized BERT approach (ROBERTa), or efficiently learning an encoder that classifies token replacements accurately (ELECTRA). The language model used for improving the code is not limited to the above.

In a case where the determination unit 16 determines to use the post-improvement code, the code improvement unit 12 further improves the post-improvement code using the language model based on a prompt, for example. In a case where the determination unit 16 determines not to use the post-improvement code, the code improvement unit 12 further improves the pre-improvement code using the language model based on a prompt, for example. In a case where the determination unit 16 determines to reject the code that has been improved, the code improvement unit 12 improves the pre-improvement code using the language model based on a prompt with the pre-improvement code as a target of improvement. Rejecting a code means, for example, excluding the code from the target of improvement. The rejection of the code is performed, for example, in a case where an error occurs during the execution of the code. The rejection of the code may be performed in a case where the output data for the input data at the time of executing the code does not match the correct answer data.

In a case of repeating improvement of the code, the code improvement unit 12 improves the code based on the same prompt, for example. For example, in a case where the determination unit 16 determines to use the post-improvement code, the code improvement unit 12 further improves the post-improvement code based on the prompt same as the prompt used for improving the code. Repeating improvement of the code means, for example, performing improvement a plurality of times on the code of the improvement source acquired by the acquisition unit 11. For example, repeating improvement of a code means repeating a series of processing cycles including improvement of a code in the code improvement unit 12, execution of a code in the execution unit 13, evaluation of execution performance of a code in the evaluation unit 15, determination by the determination unit 16 of whether to use a post-improvement code, and improvement by the code improvement unit 12 of a code determined to be used. In a case where the code is repeatedly improved, the code to be improved again may include the pre-improvement code. For example, in a case where it is determined that the post-improvement code is not used or in a case where the execution of the code is not normally performed, the code improvement unit 12 improves not the code for which the evaluation of the execution performance has been performed but the code, before the improvement, that is to be evaluated.

When code improvement is repeatedly performed, the code improvement unit 12 may improve the code, for example, based on a prompt changed from a previous improvement in repetition. The changed prompt is input, for example, by the person in charge who generates the code. The code improvement unit 12 may improve the code based on the prompt generated by the prompt generation unit 17. In a case where the code correction unit 14 performs debugging of a code in which an error has occurred at the time of executing the code, the code improvement unit 12 improves the code after debugging, for example.

The processing related to improvement of the code may be performed in a device outside the code improvement device 10. In a case where the processing related to improvement of the code is performed by a device outside the code improvement device 10, the code improvement unit 12 outputs a prompt indicating the content of improvement of the code and a code to be improved to, for example, an information processing device in which a language model that performs a process of improving the code operates. The code improvement unit 12 acquires the improved code from the information processing device that has improved the code, for example.

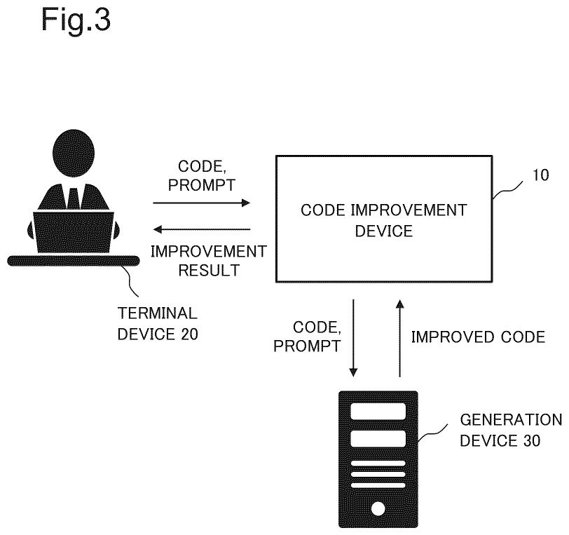

FIG. 3 illustrates an example of a configuration of a code improvement system that performs processing related to code improvement by a generation device 30. In the example of FIG. 3, the code improvement device 10 is connected to the generation device 30 via, for example, a network. The generation device 30 is, for example, an information processing device that generates an improved code from an input code using a language model. The code improvement unit 12 outputs, for example, a code to be improved and a prompt indicating the content of the improvement of the code to the generation device 30. The generation device 30 generates the improved code using the code to be improved and the prompt indicating the content of the improvement of the code as the input of the language model. The code improvement unit 12 acquires an improved code from the generation device 30 that has improved the code.

The execution unit 13 executes a process using the code improved by the code improvement unit 12. For example, the execution unit 13 executes the code improved by the code improvement unit 12 using the input data acquired as the correct answer data, and acquires output data as an execution result of the code. The execution unit 13 measures execution performance at the time of executing the code. For example, the execution unit 13 measures at least one of the execution time of the code, the memory consumption amount at the time of executing the code, and the power consumption at the time of executing the code as the execution performance. The execution time of the code is, for example, a time from the start of the execution of the code to the end of the execution of the code. The memory consumption amount is, for example, a capacity of a memory used at the time of executing the code. For example, the execution unit 13 measures the size of the maximum storage area among the storage areas on the memory occupied at the time of executing the code as the memory consumption amount. The execution unit 13 measures, for example, a parameter necessary for calculation of power consumption. For example, the execution unit 13 measures the processed data amount, the consumption of the memory, and the number of accesses to the storage device as parameters necessary for calculating the power consumption amount. The parameter necessary for the calculation of the power consumption is not limited to the above. The execution performance measured by the execution unit 13 is not limited to the above.

The execution unit 13 may execute the same code a plurality of times. The number of times of executing the same code is set such that a significant evaluation result can be acquired, for example, in a case where a statistical value is calculated in the evaluation of the execution performance. In a case where the same code is executed a plurality of times, the execution unit 13 measures the execution performance each time the code is executed, for example. In a case where the same code is executed a plurality of times, the execution unit 13 may suspend the execution of the code a plurality of times in a case where an error occurs during the execution of the code.

When an error occurs at the time of execution, the execution unit 13 extracts information indicating contents of the error as an error message. The error message is, for example, information indicating a phenomenon occurring in a case where the execution of the code is stopped or a factor of the stop. When an error occurs at the time of execution, the execution unit 13 may identify a location where the error has occurred in the code.

The execution unit 13 may execute the code in an information processing device in which the code is actually used. The information processing device in which the code is actually used is also referred to as, for example, a target machine. For example, the execution unit 13 outputs the generated code to an information processing device in which the code is actually used, and acquires an execution result of the code in the information processing device. Actually using the code means, for example, that the code is executed to process actual data. For example, in a case where the code is a code of a program for managing sales in a store, the information processing device in which the code is actually used is a device for managing sales data of the store.

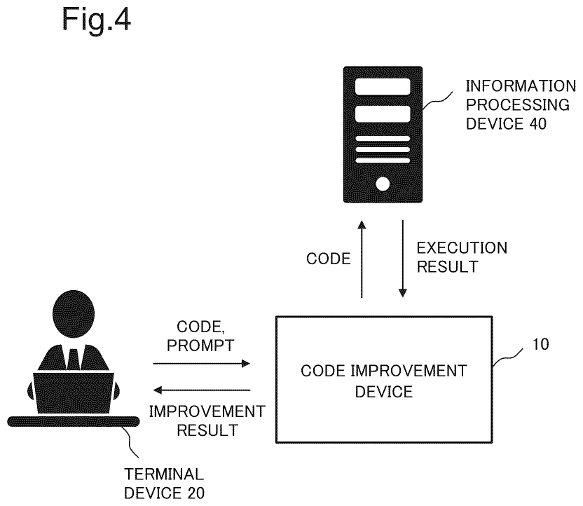

FIG. 4 illustrates an example of a configuration of a code improvement system that executes a code by an information processing device 40. In the example of FIG. 4, the code improvement device 10 is connected to the information processing device 40 via a network, for example. For example, the information processing device 40 processes data by executing a code of a program. The execution unit 13 outputs the code improved by the code improvement unit 12 to the information processing device 40, for example. For example, the execution unit 13 outputs the input data among the correct answer data to the information processing device 40 as test data. The information processing device 40 executes the code using the test data as input data. The execution unit 13 acquires output data as an execution result of the code in the information processing device 40 from the information processing device 40 that has executed the code. The execution unit 13 acquires, for example, information indicating execution performance at the time of executing the code from the information processing device 40. In a case where an error occurs at the time of executing the code, the execution unit 13 acquires an error message indicating the content of the error from the information processing device 40.

In a case where the code is executed by the information processing device in which the code is actually used, the execution unit 13 may execute the code every predetermined number of times in the repetition of the processing related to the improvement in the information processing device in which the code is actually used. The predetermined number of times is set, for example, in such a way that the execution performance in the actual operation environment can be appropriately evaluated while the load on the information processing device is suppressed. For example, in a case where the predetermined number of times is 5, the execution unit 13 executes the codes generated by the first to fourth improvements in the repetition of the improvement in the code improvement device 10, and executes the code generated in the fifth improvement in the information processing device in which the code is actually used. For example, the execution unit 13 executes the codes generated by the sixth to ninth improvements in the repetition of the improvements in the code improvement device 10, and executes the code generated in the tenth improvement in the information processing device in which the code is actually used. As described above, by executing the improved code by the information processing device in which the code is actually used in some of the repetition times, for example, it is possible to generate the code suitable for the actual operation environment while suppressing the load of the information processing device.

In a case where the code is executed by the information processing device in which the code is actually used, the execution unit 13 may execute the code whose execution performance in the code improvement device 10 is equal to or higher than the standard in the information processing device in which the code is actually used. As described above, in a case where the information processing device in which the code is actually used executes only the code having the execution performance equal to or higher than the reference, for example, it is possible to generate a code having high execution performance while suppressing the load of the information processing device.

The execution unit 13 may execute the code in a simulator that reproduces an information processing device in which the code is actually used. For example, the execution unit 13 executes the code improved by the code improvement unit 12 in the simulator using the input data included in the test data. The execution unit 13 acquires output data for the input data as a simulation result. The execution unit 13 acquires, for example, execution performance measured by the simulator at the time of executing the code.

The execution unit 13 may execute the code using a simulator and an information processing device in which the code is actually used. The execution unit 13 executes the code every predetermined number of times in the repetition of the processing related to the improvement in the information processing device in which the code is actually used, and executes the code using the simulator in the normal repetition. The predetermined number of times is set, for example, in such a way that the execution performance in the actual operation environment can be appropriately evaluated while the load on the information processing device is suppressed. For example, in a case where the predetermined number of times is 5, the execution unit 13 executes the codes generated by the first to fourth improvements in the repetition of the improvements in the simulator, and executes the code generated by the fifth improvement in the information processing device in which the code is actually used. For example, the execution unit 13 executes the code generated by the sixth to ninth improvements in the repetition of the improvements in the simulator, and executes the code generated by the tenth improvement in the information processing device in which the code is actually used. As described above, by executing the code using the information processing device in which the code is actually used and the simulator, it is possible to generate the code suitable for the actual operation environment while suppressing the load of the information processing device.

For example, in a case where an error occurs at the time of executing the code, the code correction unit 14 corrects the code using a prompt including an error message and the code in which the error has occurred as inputs of the language model. That is, for example, in a case where an error occurs during execution of the code, the code correction unit 14 performs debugging of the code using the language model. For example, the code correction unit 14 corrects the code using a prompt including a constraint based on the error message as an input of the language model. For example, in a case where an error message indicating that an error has occurred in processing that requires a graphics processing unit (GPU) is acquired, the code correction unit 14 corrects the code with a prompt “Please correct the following code to a code operating without GPU” as an input of the language model.

The code correction unit 14 may correct the code in a case where the output data for the input data at the time of executing the code does not match the correct answer data. For example, the code correction unit 14 identifies a function that can be a factor that the output data for the input data at the time of executing the code does not match the correct answer data. The code correction unit 14 corrects the code using a prompt including an instruction to correct the identified function as an input to the language model

The code correction unit 14 corrects the code, for example, based on the evaluation result of the evaluation unit 15. When an error occurs in the execution of the code in the execution unit 13, the code correction unit 14 may correct the code in which the error has occurred. The prompt used to correct the code may be input by a person in charge who generates the code.

As a language model for correcting the code, for example, GPT-2, GPT-3, GPT-3.5, or GPT-4 can be used. T5, BERT, ROBERTa, or ELECTRA may be used as the language model. The language model used for improving the code is not limited to the above. The language model for correcting the code may be the same language model as the language model for improving the code, or may be a different language model.

The evaluation unit 15 evaluates the code based on the execution result of the code, for example. As the evaluation of the code, the evaluation unit 15 evaluates the execution performance of the code based on the execution result of the code. For example, the evaluation unit 15 evaluates the execution performance of the code based on an execution result in a case where the same code is executed a plurality of times. For example, the evaluation unit 15 calculates a statistical value of the execution performance in a case where the same code is executed a plurality of times as an evaluation result of the execution performance of the code. The statistical value is, for example, an average value. The statistical value may be modes, medians or standard deviations. The statistical value is not limited to the above.

For example, in a case where the execution performance is the processing time of the code, the evaluation unit 15 calculates, for example, an average value of the processing time in a case where the code is executed a plurality of times as an evaluation result regarding the processing time. In a case where the code is executed by the simulator, the evaluation unit 15 may measure the processing time necessary for executing the code for each configuration of the information processing device. For example, the processing speed of the code may greatly change depending on the presence or absence of the GPU. For example, in a case where the code is executed by the simulator, the evaluation unit 15 calculates the processing time of the code in each of the setting in which the information processing device including the GPU is reproduced and the setting in which the information processing device not including the GPU is reproduced.

The evaluation unit 15 may calculate the power consumption at the time of executing the code as an evaluation result based on the power consumption of each piece of hardware used for executing the code. For example, the evaluation unit 15 calculates the power consumption at the time of executing the code based on the processed data amount, the memory consumption amount, and the number of accesses to the storage device. The relationship between each of the processed data amount, the memory consumption amount and the number of accesses to the storage device, and the power consumption is set as data in a table format based on, for example, a hardware specification. The power consumption at the time of executing the code is calculated.

The evaluation unit 15 may evaluate the readability of the code as the execution performance of the code. The evaluation unit 15 evaluates the readability of the code based on, for example, the length of the code, the presence or absence of the comment, and the length of the comment. The relationship between each of the length of the code, the presence or absence of the comment and the length of the comment, and the evaluation value of the readability is set as, for example, data in a table format. The items used for evaluation of readability are not limited to the above. The execution performance evaluated by the evaluation unit 15 is not limited to the above.

The evaluation unit 15 evaluates, for example, whether an error has occurred at the time of executing the code. When an error occurs, the evaluation unit 15 outputs an error message to the code correction unit 14, for example. The evaluation unit 15 may identify the content or cause of the error based on the error message. The evaluation unit 15 may identify the content or cause of the error based on the place where the error has occurred in the code. For example, in a case where an error occurs at a portion requiring processing in the GPU for executing the code, the evaluation unit 15 identifies that the GPU is not provided as the cause of the error. When identifying the content or cause of the error, the evaluation unit 15 outputs the identified content or cause of the error to the code correction unit 14, for example.

For example, the evaluation unit 15 may evaluate whether the code is normal based on output data at the time of executing the code in the execution unit 13. For example, the evaluation unit 15 evaluates whether the code is normally executed based on the correct answer data acquired together with the code. The evaluation unit 15 compares the execution result of the code acquired by the execution unit 13 with the data included in the correct answer data. When the output data included in the execution result of the code acquired by the execution unit 13 matches the data included in the correct answer data, the evaluation unit 15 evaluates that the code has been normally executed. In a case where the output data that does not match the data included in the correct answer data is included in the execution result of the code acquired by the execution unit 13, the evaluation unit 15 evaluates, for example, that the code is not normally executed. That is, in a case where the code execution result acquired by the execution unit 13 includes output data that does not match the data included in the correct answer data, the evaluation unit 15 evaluates that an abnormality has occurred in the code execution result.

The determination unit 16 determines whether to use the post-improvement code based on the evaluation result of the execution performance of the code. For example, in a case where the evaluation result of the execution performance satisfies a predetermined criterion, the determination unit 16 determines to use the post-improvement code. For example, in a case where the evaluation result of the execution performance satisfies a predetermined criterion, the post-improvement code is determined as the code to be further improved. For example, in a case where the execution performance is evaluated for a second code obtained by improving a first code, in a case where the execution performance of the second code satisfies a predetermined criterion, the determination unit 16 determines to use the second code as the code to be improved. In this case, the code improvement unit 12 improves the second code based on a prompt, for example, to generate a third code. Using the post-improvement code may include setting the post-improvement code as a storage target.

For example, in a case where the evaluation result of the execution performance does not satisfy the predetermined criterion, the determination unit 16 determines not to use the post-improvement code. That is, for example, in a case where the evaluation result of the execution performance does not satisfy the predetermined criterion, the determination unit 16 determines the pre-improvement code as the code to be improved. For example, in a case where the execution performance is evaluated for the second code obtained by improving the first code, in a case where the execution performance of the second code does not satisfy the predetermined criterion, the determination unit 16 determines the first code as the code to be improved without using the second code. In this case, the code improvement unit 12 improves the first code based on a prompt, for example, to generate the third code. That is, the second code is rejected, and the first code used to generate the second code is used again as the code to be improved. The code generated by the language model is, for example, a different code for each generation even if generation is performed based on the same prompt. Therefore, even in a case where the same first code is targeted for improvement, the second code generated by the improvement and the third code may be different codes from each other.

The determination unit 16 may determine a code having high execution performance among the two codes before and after the improvement as a code to be improved. For example, in a case where the execution performance is evaluated for the second code obtained by improving the first code, in a case where the execution performance of the second code is higher than the execution performance of the first code, the determination unit 16 uses the second code and determines the second code as a code to be improved. For example, in a case where the execution performance is evaluated for the second code obtained by improving the first code, in a case where the execution performance of the second code is lower than the execution performance of the first code, the determination unit 16 determines the first code as the code to be improved without using the second code.

The determination unit 16 may determine whether to use the post-improvement code based on the evaluation result of the execution performance of the plurality of items. For example, in a case where the power consumption required for executing the code and the memory consumption amount satisfy the criteria, the determination unit 16 determines to use the post-improvement code whose execution performance satisfies the criteria. The determination unit 16 may determine whether to use the post-improvement code based on the score calculated by weighting the evaluation result of the execution performance of the plurality of items.

The determination unit 16 may determine whether to reject the improved code. For example, the determination unit 16 determines to reject the post-improvement code in a case where an error occurs at the time of executing the code or in a case where the output data for the input data at the time of executing the code does not match the correct answer data. In a case where the post-improvement code is rejected, for example, the pre-improvement code is to be improved. The determination unit 16 may make a determination to end the processing related to code improvement in a case where the end condition is satisfied in a case where the execution performance of the code is evaluated.

The end condition is set, for example, based on the number of repetitions of improvement of the code or the number of codes whose execution performance satisfies the criterion. When the person in charge of generating the code inputs information indicating that the generation of the code is ended, the determination unit 16 may make a determination to end the processing related to the improvement of the code.

The prompt generation unit 17 generates a prompt, for example, based on an evaluation result of the code. The prompt generation unit 17 generates a prompt using, for example, fixed phrases set according to code execution performance. For example, in a case where the processing time does not meet the criterion, the prompt generation unit 17 generates a prompt indicating to suppress the number of branches. The relationship between the execution performance of the code and the change content of the prompt is set as, for example, data in a table format. The changed prompt may be input by the person in charge who generates the code.

The prompt generation unit 17 may generate a prompt based on an item that is emphasized by the person in charge who generates the code. For example, in a case where the acquisition unit 11 acquires the information indicating the change point of the prompt, the prompt generation unit 17 generates the prompt based on the acquired information indicating the change point. For example, in a case where suppression of the number of branches is designated as the information indicating the change point, the prompt generation unit 17 generates a prompt indicating suppression of the number of branches.

The output unit 18 outputs, for example, information about a code improvement result. For example, the output unit 18 outputs the evaluation result of the execution performance as information about the improvement result of the code. The output unit 18 may output the improved code as information about an improvement result of the code. The output unit 18 may output a list indicating the information about the improved code as the information about the improvement result of the code. The output unit 18 may output an evaluation result of each of the plurality of execution performances.

The output unit 18 may store the improved code in the storage unit 19. The output unit 18 may store the improved code in a storage means other than the storage unit 19. For example, the output unit 18 stores the improved code and the evaluation result of the execution performance of the code in association with each other. In a case where the evaluation is performed for each of the plurality of execution performances, the output unit 18 stores the improved code and the evaluation result of the plurality of execution performances in the code in association with each other.

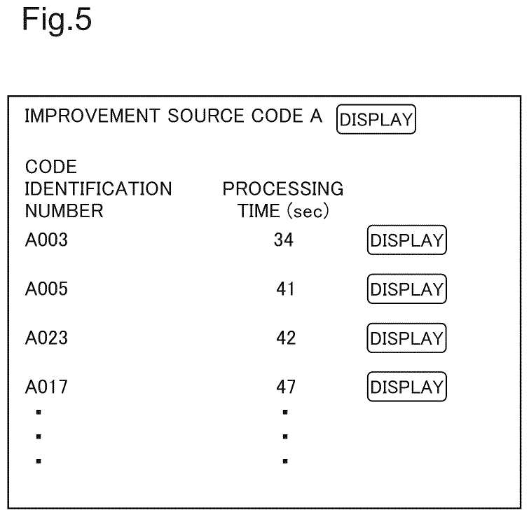

FIG. 5 is an example of a display screen of information about a code improvement result. The example of the display screen of FIG. 5 illustrates an evaluation result of the execution performance of the code. In the example of the display screen of FIG. 5, the “improvement source code” indicating a code name of an improvement source and execution performance for each of the post-improvement codes are displayed. In the example of the display screen of FIG. 5, the “code identification number” which is an identifier of each of the post-improvement codes is associated with the “processing time (sec)” indicating the evaluation result of the execution performance. “The processing time (sec)” is, for example, a time required for executing the code by the execution unit 13. In the example of the display screen of FIG. 5, buttons for displaying the improvement source code and the post-improvement code are displayed as “display”. In the example of the display screen of FIG. 5, the post-improvement codes are displayed in ascending order of the processing time. For example, the person in charge of generating the code can easily select the code having high execution performance by referring to the information about the improvement result as in the example of FIG. 5.

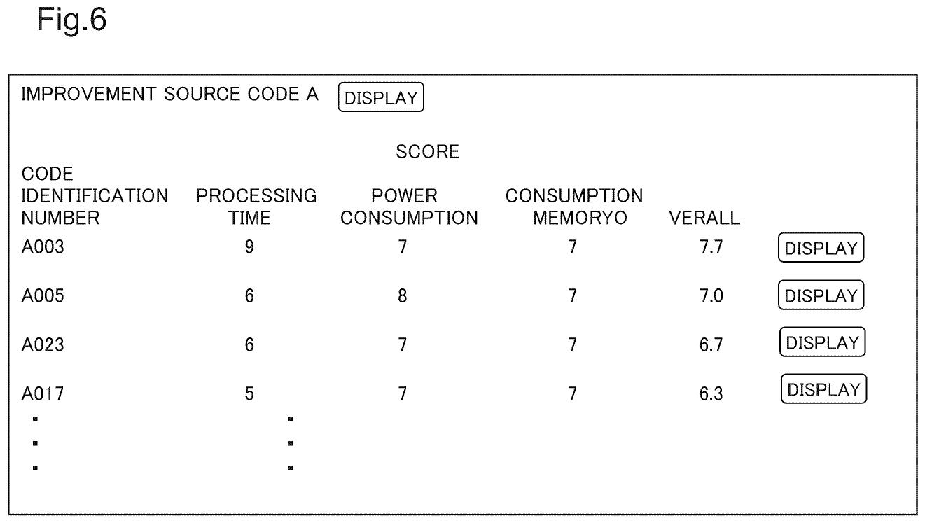

FIG. 6 is an example of a display screen that displays a score of each execution performance for a post-improvement code as information about an improvement result of the code. In the example of the display screen of FIG. 6, an “improvement source code” indicating a code name of an improvement source and a score indicating execution performance for each of the post-improvement codes are displayed. In the example of the display screen of FIG. 6, the “code identification number” which is an identifier of each of the post-improvement codes is associated with the “score” indicating the evaluation result of the execution performance. In the example of the display screen of FIG. 6, scores of the “processing time”, the “power consumption”, the “memory consumption”, and the “overall” are displayed for each of the post-improvement codes. In the example of the display screen of FIG. 6, the score of the “processing time” is a score calculated based on the processing time of the code. In the example of the display screen of FIG. 6, the score of the “power consumption” is a score calculated based on the power consumption at the time of executing the code. In the example of the display screen of FIG. 6, the score of the “memory consumption” is a score calculated based on the memory consumption amount at the time of executing the code. In the example of the display screen of FIG. 6, the score of the “overall” is, for example, an average value of scores of the “processing time”, the “power consumption”, and the “memory consumption”. In the example of the display screen of FIG. 6, buttons for displaying the improvement source and the post-improvement code are displayed as the “display”. In the example of the display screen of FIG. 6, the post-improvement codes are displayed in ascending order of the processing time. For example, the person in charge of generating the code can select the code according to the execution performance to be emphasized by referring to the information about the improvement result as in the example of FIG. 6.

The storage unit 19 stores, for example, data related to processing of improving a code. The storage unit 19 stores, for example, the code to be improved acquired by the acquisition unit 11. The storage unit 19 stores, for example, correct answer data of the input/output data acquired by the acquisition unit 11. The storage unit 19 stores, for example, a prompt used for improving the code. The storage unit 19 stores, for example, an evaluation criterion in the evaluation of the execution performance of the code. The storage unit 19 stores, for example, an improved code. For example, the storage unit 19 stores the improved code and the evaluation result of the execution performance in association with each other.

The terminal device 20 is, for example, a terminal device used by a user of the code improvement system. The user of the code improvement system is, for example, a person in charge of generating the code of the program. The terminal device 20 acquires, for example, a code to be improved and a prompt indicating the content of improvement of the code, which are input by a user's operation. The terminal device 20 outputs, for example, the code to be improved and a prompt indicating the content of the improvement of the code to the acquisition unit 11 of the code improvement device 10. The terminal device 20 acquires, for example, information about a code improvement result from the output unit 18 of the code improvement device 10. The terminal device 20 outputs information about a code improvement result to a display device (not illustrated), for example. As the terminal device 20, for example, a notebook personal computer or a desktop personal computer can be used. The terminal device 20 is not limited to the above.

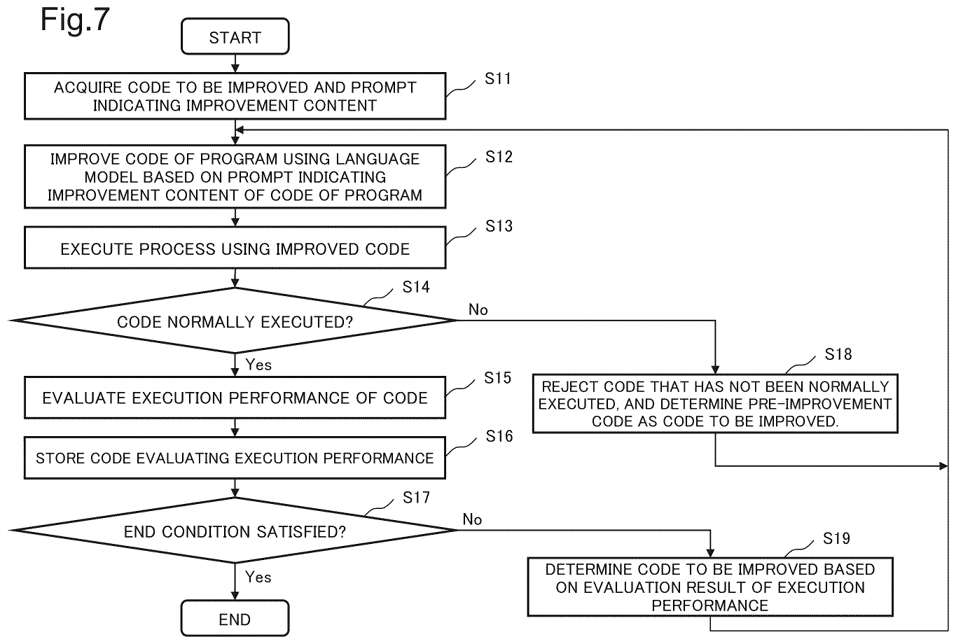

Processing of improving the code of the program in the code improvement device 10 will be described. FIG. 7 illustrates an example of an operation flow in a process of improving the code of the program in the code improvement device 10.

The acquisition unit 11 acquires, for example, a code to be improved and a prompt indicating an improvement content (step S11).

When the code to be improved and the prompt indicating the improvement content are acquired, the code improvement unit 12 improves the code of the program using the language model that improves a code of a program based on the prompt indicating the improvement content of a code of a program (step S12).

When the code is improved, the execution unit 13 executes a process using the improved code (step S13).

In a case where the code has been normally executed (Yes in step S14), the evaluation unit 15 evaluates the execution performance of the code based on the execution result of the code (step S15).

When the execution performance of the code is evaluated, the output unit 18 stores, for example, the code and the evaluation result of the execution performance of the code in association with each other in the storage unit 19.

When the code and the evaluation result of the execution performance are stored in step S16 and the end criterion of the processing related to the improvement of the code is not satisfied (No in step S17), the determination unit 16 determines a code to be improved based on the evaluation result of the execution performance, for example (step S19). The determination unit 16 determines the code to be improved by determining whether to use the post-improvement code based on the evaluation result of the execution performance.

When the code to be improved is determined, the process returns to step S12, and the code improvement unit 12 improves, for example, the code determined to be improved.

When the code and the evaluation result of the execution performance are stored in step S16, in a case where the end criterion of the processing related to the improvement of the code is satisfied (Yes in step S17), the code improvement device 10 ends the process related to the improvement of the code.

In a case where the code is not normally executed in the process of executing the code in step S13 (No in step S14), the determination unit 16 rejects the code that has not been normally executed, and determines the pre-improvement code as the code to be improved (step S18). When the code to be improved is determined, the process returns to step S12, and the code improvement unit 12 improves the code determined to be improved, for example.

The code improvement device 10 improves the code of the program using a language model that improves a code of a program based on a prompt indicating an improvement content of a code of a program. The code improvement device 10 executes a process using the improved code. The execution performance of the code is evaluated based on the execution result of the code. The code improvement device 10 determines whether to use the post-improvement code based on the evaluation result of the execution performance.

As described above, by improving the code using the language model and determining whether to use the post-improvement code based on the evaluation result of the execution performance, a code with high performance can be automatically generated. Therefore, the code improvement device 10 can efficiently improve the code of the program.

In a case where an error occurs during execution of the code, in a case where the code in which the error has occurred is debugged using the language model, the code improvement device 10 can utilize the code usable by debugging, for example, by debugging the improved code, and thus can efficiently generate various codes. By correcting the code in which the error has occurred by debugging and rejecting the code in which the output data does not match the correct answer data, the code improvement device 10 can generate various codes more efficiently.

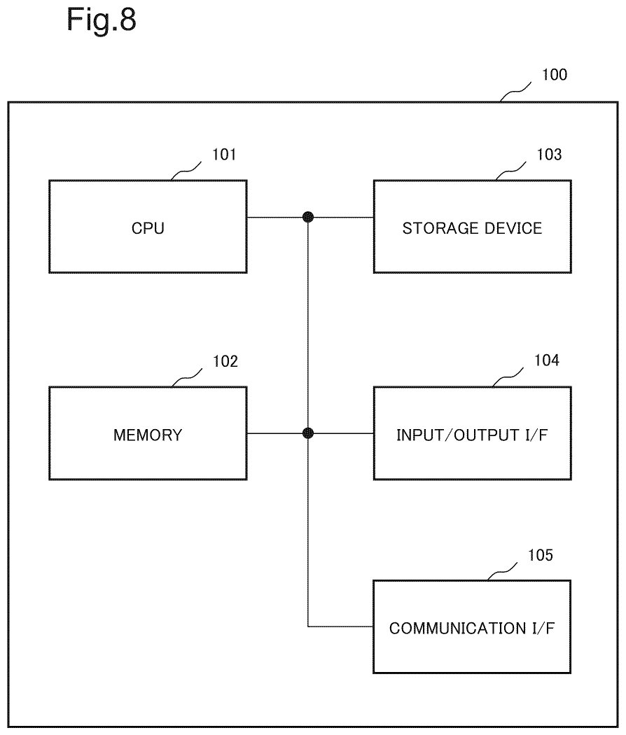

Each processing in the code improvement device 10 can be implemented by executing a computer program on a computer. FIG. 8 illustrates an example of a configuration of a computer 100 that executes a computer program for executing each processing in the code improvement device 10. The computer 100 includes a central processing unit (CPU) 101, a memory 102, a storage device 103, an input/output interface (I/F) 104, and a communication I/F105.

The CPU 101 reads and executes a computer program for executing each processing from the storage device 103. The CPU 101 may be configured by a combination of a plurality of CPUs. The CPU 101 may be configured by a combination of the CPU and another type of processor. For example, the CPU 101 may be configured by a combination of a CPU and a graphics processing unit (GPU). The memory 102 includes a dynamic random access memory (DRAM) or the like, and temporarily stores a computer program executed by the CPU 101 and data being processed. The storage device 103 stores a computer program executed by the CPU 101. The storage device 103 includes, for example, a nonvolatile semiconductor storage device. The storage device 103 may include another storage device such as a hard disk drive. The input/output I/F 104 is an interface that receives an input from an operator to output display data and the like. The communication I/F105 is an interface that transmits and receives data to and from the terminal device 20, the generation device 30, the information processing device 40, and other information processing devices. The terminal device 20, the generation device 30, and the information processing device 40 may have configurations similar to those of the computer 100.

The computer program used for executing each processing can also be distributed by being stored in a computer-readable recording medium that non-transiently records data. The recording medium may include, for example, a magnetic tape for data recording or a magnetic disk such as a hard disk. The recording medium may include an optical disk such as a compact disc read only memory (CD-ROM). A non-volatile semiconductor storage device may be used as a recording medium.

In the program used in the information processing device, for example, resources and processing time required at the time of execution may change depending on the quality of the code. Therefore, for example, the person in charge of generating the program suppresses resources and processing time required at the time of execution by improving the created code. On the other hand, in the improvement of the program, it is necessary to repeat the code rewriting, the execution, and the evaluation of the code based on the execution result, so that the required workload can be increased. In the technique described in the background art, there is a case where work in improving the code of the program is redundant.

Therefore, in order to solve the above problems, an object of the present disclosure is to provide a code improvement device and the like capable of efficiently improving a code of a program.

Using the code improvement device or the like of the present disclosure, the code of the program can be efficiently improved.

Some or all of the above-described example embodiments may be described as the following Supplementary Notes, but are not limited to the following Supplementary Notes.

### Supplementary Note 1

A code improvement device including
a code improvement unit that improves a code of a program, to generate a post-improvement code, using a language model that improves a code of a program based on a prompt indicating improvement content of the code of the program,
an execution unit that executes a process using the post-improvement code,
an evaluation unit that evaluates execution performance of the post-improvement code based on an execution result of the post-improvement code, and
a determination unit that determines whether to use the post-improvement code based on an evaluation result of the execution performance.

### Supplementary Note 2

The code improvement device according to Supplementary Note 1, wherein
in a case where it is determined to use a post-improvement code, the code improvement unit improves the post-improvement code as a target of improvement using the language model based on the prompt, and in a case where it is determined not to use a post-improvement code, the code improvement unit improves a pre-improvement code as a target of improvement again using the language model based on the prompt.

### Supplementary Note 3

The code improvement device according to Supplementary Note 2, wherein
the code improvement unit improves a code to be improved of the post-improvement code and the pre-improvement code based on a prompt same as the prompt used for improving a code.

### Supplementary Note 4

The code improvement device according to any one of Supplementary Notes 1 to 3, wherein
the evaluation unit evaluates execution performance of the cpost-improvement code in a case where the post-improvement code is normally executed.

### Supplementary Note 5

The code improvement device according to any one of notes 1 to 4, further including
a code correction unit that corrects, in a case where an error occurs during execution of a code, the error of the code using a prompt including an error message as an input of the language model, wherein
the code improvement unit improves, based on the prompt, the code in which the error is corrected using the language model.

### Supplementary Note 6

The code improvement device according to any one of Supplementary Notes 1 to 5, wherein
the execution unit outputs the generated code to an information processing device in which the post-improvement code is actually used, and acquires an execution result of the post-improvement code in the information processing device.

### Supplementary Note 7

The code improvement device according to any one of Supplementary Notes 1 to 5, wherein
the execution unit executes the post-improvement code in a simulator that reproduces an information processing device in which the post-improvement code is actually used.

### Supplementary Note 8

The code improvement device according to any one of Supplementary Notes 1 to 7, wherein
the determination unit determines a code to be improved based on an evaluation result of execution performance in a plurality of items.

### Supplementary Note 9

The code improvement device according to any one of notes 1 to 8, further including
an output unit that outputs an evaluation result of the execution performance.

### Supplementary Note 10

The code improvement device according to Supplementary Note 9, wherein
the output unit stores the post-improvement code and an evaluation result of execution performance of the post-improvement code in association with each other.

### Supplementary Note 11

The code improvement device according to Supplementary Note 9, wherein
the output unit outputs an evaluation result of each of a plurality of execution performances.

### Supplementary Note 12

The code improvement device according to any one of Supplementary Notes 1 to 11, wherein
the execution performance includes at least one of an execution time of a code, a memory consumption amount at a time of execution of the code, power consumption at a time of execution of the code, and readability.

### Supplementary Note 13

The code improvement device according to any one of Supplementary Notes 1 to 12, further including
a prompt generation unit that generates the prompt based on an evaluation result of the post-improvement code.

### Supplementary Note 14

The code improvement device according to Supplementary Note 13, further including
an acquisition unit that acquires information indicating a change point of the prompt, wherein
the prompt generation unit generates the prompt based on the acquired information indicating the change point.

### Supplementary Note 15

A code improvement method including
improving a code of a program, to generate a post-improvement code, using a language model that improves a code of a program based on a prompt indicating improvement content of a code of a program,
executing a process using the post-improvement code,
evaluating execution performance of the post-improvement code based on an execution result of the post-improvement code, and
determining whether to use the post-improvement code based on an evaluation result of the execution performance.

### Supplementary Note 16

A non-transitory recording medium storing a code improvement program for causing a computer to execute the steps of
improving a code of a program, to generate a post-improvement code, using a language model that improves a code of a program based on a prompt indicating improvement content of the code of the program,
executing a process using the post-improvement code,
evaluating execution performance of the code based on an execution result of the post-improvement code, and
determining whether to use the post-improvement code based on an evaluation result of the execution performance.

Some or all of the configurations described in Supplementary Notes 2 to 14 dependent on the above-described Supplementary Note 1 can also depend on Supplementary Notes 15 and 16 by the same dependency relationship as Supplementary Notes 2 to 19. Furthermore, some or all of the configurations described as the Supplementary Notes can be similarly dependent on not only the Supplementary Notes 1, 15, and 16, but also various pieces of hardware and software, and various recording means or systems for recording software without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A code improvement device comprising:
at least one memory storing instructions; and
at least one processor configured to access the at least one memory and execute the instructions to:
improve a code of a program, to generate a post-improvement code, using a language model that improves a code of a program based on a prompt indicating improvement content of the code of the program;
execute a process using the post-improvement code;
evaluate execution performance of the post-improvement code based on an execution result of the post-improvement code; and
determine whether to use the post-improvement code based on an evaluation result of the execution performance.

2. The code improvement device according to claim 1, wherein
the at least one processor is further configured to execute the instructions to:
in a case where it is determined to use the post-improvement code, improve the post-improvement code as a target of improvement using the language model based on the prompt, and in a case where it is determined not to use the post-improvement code, improve a pre-improvement code as a target of improvement again using the language model based on the prompt.

3. The code improvement device according to claim 2, wherein
the at least one processor is further configured to execute the instructions to:
improve a code to be improved of the post-improvement code and the pre-improvement code based on a prompt same as the prompt used for improving a code.

4. The code improvement device according to claim 1, wherein
the at least one processor is further configured to execute the instructions to:
evaluate execution performance of the code in a case where post-improvement code is normally executed.

5. The code improvement device according to claim 1, wherein
the at least one processor is further configured to execute the instructions to:
correct, in a case where an error occurs during execution of a code, the error of the code using a prompt including an error message as an input of the language model; and
improve, based on the prompt, the code in which the error is corrected using the language model.

6. The code improvement device according to claim 2, wherein
the at least one processor is further configured to execute the instructions to:
in a case where an error occurs during execution of the code, correct the error of the code using a prompt including an error message as an input of the language model; and
improve, based on the prompt, the code in which the error is corrected using the language model.

7. The code improvement device according to claim 1, wherein
the at least one processor is further configured to execute the instructions to:
output the post-improvement code to an information processing device in which the code is actually used; and
acquire an execution result of the code in the information processing device from the information processing device.

8. The code improvement device according to claim 2, wherein
the at least one processor is further configured to execute the instructions to:
output the post-improvement code to an information processing device in which the code is actually used; and
acquire an execution result of the code in the information processing device from the information processing device.

9. The code improvement device according to claim 1, wherein
the at least one processor is further configured to execute the instructions to:
execute the post-improvement code in a simulator that reproduces an information processing device in which the code is actually used.

10. The code improvement device according to claim 1, wherein
the at least one processor is further configured to execute the instructions to:
determine a code to be improved based on an evaluation result of execution performance in a plurality of items.

11. The code improvement device according to claim 1, wherein
the at least one processor is further configured to execute the instructions to:
output an evaluation result of the execution performance.

12. The code improvement device according to claim 11, wherein
the at least one processor is further configured to execute the instructions to:
store the post-improvement code and an evaluation result of execution performance of the post-improvement code in association with each other.

13. The code improvement device according to claim 11, wherein
the at least one processor is further configured to execute the instructions to:
output an evaluation result of each of a plurality of execution performances.

14. The code improvement device according to claim 1, wherein
the execution performance includes at least one of an execution time of a code, a memory consumption amount at a time of execution of the code, power consumption at a time of execution of the code, and readability.

15. The code improvement device according to claim 1, wherein
the at least one processor is further configured to execute the instructions to:
generate the prompt based on an evaluation result of the post-improvement code.

16. The code improvement device according to claim 15, wherein
the at least one processor is further configured to execute the instructions to:
acquire information indicating a change point of the prompt; and
generate the prompt based on the acquired information indicating the change point.

17. A code improvement method comprising:
improving a code of a program, to generate a post-improvement code using a language model that improves a code of a program based on a prompt indicating improvement content of the code of the program;
executing a process using the post-improvement code;
evaluating execution performance of the code based on an execution result of the code; and
determining whether to use the post-improvement code based on an evaluation result of the execution performance.

18. The code improvement method according to claim 17, further comprising:
in a case where it is determined to use a post-improvement code, improving the post-improvement code as a target of improvement using the language model based on the prompt, and in a case where it is determined not to use a post-improvement code, improving a pre-improvement code as a target of improvement again using the language model based on the prompt.

19. The code improvement method according to claim 17, further comprising:
outputting the post-improvement code to an information processing device in which the code is actually used; and
acquiring an execution result of the code in the information processing device from the information processing device.

20. A non-transitory computer readable recording medium storing a code improvement program for causing a computer to execute the steps of:
improving a code of a program, to generate a post-improvement code using a language model that improves a code of a program based on a prompt indicating improvement content of the code of the program;
executing a process using the post-improvement code;
evaluating execution performance of the code based on an execution result of the code; and
determining whether to use the post-improvement code based on an evaluation result of the execution performance.
